(19) United States
(12) Patent Application Publication
(10) Pub. No.: US 2015/0047267 A1
(43) Pub. Date: Feb. 19, 2015

(54) APPARATUS AND METHOD FOR MONITORING A ROOF DRAIN SYSTEM

(71) Applicant: Linda May, West Bridgewater, MA (US)

(72) Inventors: Scott Arthur May, West Bridgewater, MA (US); Linda May, West Bridgewater, MA (US)

(21) Appl. No.: 13/969,540

(22) Filed: Aug. 17, 2013

(51) Int. Cl. E04D 13/076; G08B 5/00

(52) U.S. Cl. CPC E04D 13/0765; E04D 13/076; G08B 5/00
USPC 52/12; 29/402.01

(57) ABSTRACT

The present invention provides a high-visibility roof-drain system for inspecting and unblocking roof-drains in a large building having a flat roof and typically multiple high visibility roof-drain covers coupled to multiple internal drainpipes. Each internal drainpipe defines a drainpipe inlet on the roof of the building, and a drainpipe outlet proximate to the level of the foundation of the building. The above-mentioned high-visibility roof-drain system preferably includes a plurality of high-visibility roof-drain covers. Each high-visibility roof-drain cover includes one roof-drain cover, one elongated, marked, reversible flag, and one flag coupler for coupling the flag to the roof-drain cover. The flag defines a first flag end and a second flag end. A first flag end is up when its associated second flag end is mounted to the roof-drain cover. A second flag end is up when its associated first flag end is mounted to the roof-drain cover. At least one of an associated pair of flag ends is visibly marked so that “first flag end up” is visibly distinguishable over “second flag end up. The benefit of this structure is that reversing the orientation of the flag, after inspecting the roof-drain-cover, provides a visual indication that an inspection has been performed.

This application is a Continuation-in-Part application that claims priority to co-owned, co-pending U.S. provisional application Ser. No. 61/212,429, filed Apr. 10, 2009, co-owned, co-pending U.S. patent application, Ser. No. 12/589,739, filed Oct. 28, 2009, now abandoned, co-owned, co-pending Canadian patent application, Ser. No. 2,696,453, filed Mar. 12, 2010, and co-owned, co-pending U.S. patent application, Ser. No. 12/803,951, filed Jul. 9, 2010.

### FIELD OF THE INVENTION

This invention relates generally to apparatus and methods for inspecting and maintaining roof-drain systems installed in commercial buildings that have flat roofs.

### BACKGROUND OF THE INVENTION

It is common practice for commercial property owners to require roof-top inspections, at suitable intervals, of roof-drains installed in large flat-roof buildings. When properly conducted, such inspections followed by diligent removal of accumulated snow, ice or debris prevent the drains from becoming blocked, so that water is allowed to drain away before it does damage. Inspections are required both during construction of a building, and during the useful life of the building.

A significant problem arising when conducting these inspections is that roof-drains can become invisible when covered by either wind-blown leaves during the fall season, or when even moderate amount of snow accumulate during the winter. Quite often, inspectors find themselves walking around the roof-top on its ice-covered, snow-covered, or leaf-covered surfaces, not entirely sure whether or not they have found all of the roof-drains on that particular roof. Also, searching ice-covered roof-tops is, by its nature, dangerous. So inspectors often find themselves guessing where the drains might be, based on prior experiences with similar commercial roofs. This is especially true when a roof is covered with six or more inches of snow. Such difficulties leave much room for error. Many drains are not found. Roof-drains that are not found are not inspected, and consequently are not cleared.

Failure to inspect a roof-drain can be catastrophic. When roof-drains are not cleared of ice and debris after a snow storm, the snow that melts during the day deposits water into areas of the roof where it is not meant to collect. Water that does not drain properly, refreezes. This causes damage to roof seams and prior roof repairs. Such damage causes various kinds of roof leaks. In foreseeable worst-case scenarios, a roof can become so compromised with damage that it becomes a safety hazard, posing such dangers as falling ceiling tiles, full ceiling collapse, partial roof collapse, and even collapse of a complete roof. Thus, failure to reliably find, inspect and clear every roof-drain on the roof of a large building can cause significant physical damage to the building. Such risks can justify high insurance premiums. Such risks can also constitute a breach of public safety, resulting in law suits. Even worse than physical damage to a building, or incurring financial loss, collapse of an entire roof can cause people in or around the building to suffer serious injury or death.

### SUMMARY OF THE INVENTION

The present application is directed to a high-visibility roof-drain system having an internal drainpipe, and to a high-visibility roof-drain cover for installation and use in flat-roofed building. The present application is also directed to a method for monitoring such roof drain systems, including preventing, and clearing blockages.

The present application is a continuation-in-part application, claiming priority to a series of earlier patent applications, including co-owned, co-pending U.S. patent application Ser. No. 12/803,951, 951, directed to “High-Visibility Roof-Drain Cover”.

The present invention provides a high-visibility roof-drain system for inspecting and unblocking roof-drains in a large building having a flat roof and typically multiple high visibility roof-drain covers coupled to multiple internal drainpipes.

Each internal drainpipe defines a drainpipe inlet on the roof of the building, and a drainpipe outlet proximate to the level of the foundation of the building.

The above-mentioned high-visibility roof-drain system preferably includes a plurality of high-visibility roof-drain covers. Each high-visibility roof-drain cover includes one roof-drain cover, one elongated, marked, reversible flag, and one flag coupler for coupling the flag to the roof-drain cover.

The flag defines a first flag end and a second flag end. A first flag end is up when its associated second flag end is mounted to the roof-drain cover. A second flag end is up when its associated first flag end is mounted to the roof-drain cover. At least one of an associated pair of flag ends is visibly marked so that “first flag end up” is visibly distinguishable over “second flag end up. The benefit of this structure is that reversing the orientation of the flag, after inspecting the roof-drain-cover, provides a visual indication that an inspection has been performed.

### BRIEF DESCRIPTION OF THE DRAWINGS

FIG. 1 shows building 10 having flat roof 11 and high-visibility roof-drain system 13. Four high-visibility roof-drain covers 12 are shown protruding from the roof.

FIG. 2 provides a partial cross-section view of one system 13, and one high-visibility roof-drain cover 12. High-visibility roof-drain cover 12 includes one elongated reversible flag 14, one flag coupler 15, one roof-drain cover 17, and one internal drainpipe 21.

FIG. 3 (prior art) is a top view of roof-drain cover 17 with central aperture 25.

FIG. 4 is a top view of the high-visibility roof-drain cover 12, also showing elongated reversible flag 14, flag coupler 15, top washer 16, and roof-drain cover 17.

FIG. 5 is a partial cross-section view of flag coupler 15. Flag coupler 15 defines threaded stub 26, and flag socket 20.

FIG. 6 shows flag coupler 15 attached to roof-drain cover 17. Threaded stub 26 passes through central aperture 25 of roof-drain cover 17. Nut 28 is shown poised to thread onto threaded stub 26.

FIG. 7 shows a portion of a second embodiment having a flag coupler 35 with threaded side aperture 36 and thumbscrew 37.

FIG. 8 shows a portion of a third embodiment having a bolt 43 poised to thread into a lower threaded cavity 42.

FIG. 9 shows a portion of a fourth embodiment. The fourth embodiment has a flag coupler 45 defining a threaded side aperture 48, and a thumbscrew 49 adapted to screw into the threaded side aperture.

FIG. 10 shows a first portion of a fifth embodiment. The fifth embodiment has a cross-section view of flag coupler 51, threaded flag socket 52, and a front view of threaded stub 53.

FIG. 11 shows a second portion of the fifth embodiment having a front view of elongated reversible lockable flag 61 having first and second flag-locking threaded ends 62 and 63.

FIG. 12 shows a first portion of a sixth embodiment. The sixth embodiment has a flag coupler 71, a threaded flag socket 72, and a lower threaded cavity 73.

FIG. 13 shows a second portion of the sixth embodiment having a front view of elongated reversible lockable flag 81 having first and second flag-locking threaded ends 82 and 83.

FIG. 14 provides a front view of high-visibility roof-drain cover 91 with flag 92, roof-drain cover 93 and centered boss 94.

FIG. 15 provides a front cross-section view of elongated reversible flag 92 mounted to roof-drain cover 93 via centered boss 94 and flag socket 95.

FIG. 16 provides a top view of high-visibility roof-drain cover 91 showing elongated reversible flag 92 and roof-drain cover 93.

FIG. 17 provides a front cross-section view of centered boss 94 and flag socket 95.

FIG. 18 provides front view of high-visibility roof-drain cover 91 sitting on rim 96 of internal drainpipe 97. Rim 96 is proximate to roof top 98. Roof-drain cover 93 is shown buried under a layer of snow 99.

### DETAILED DISCLOSURE OF INVENTION

### First Embodiment

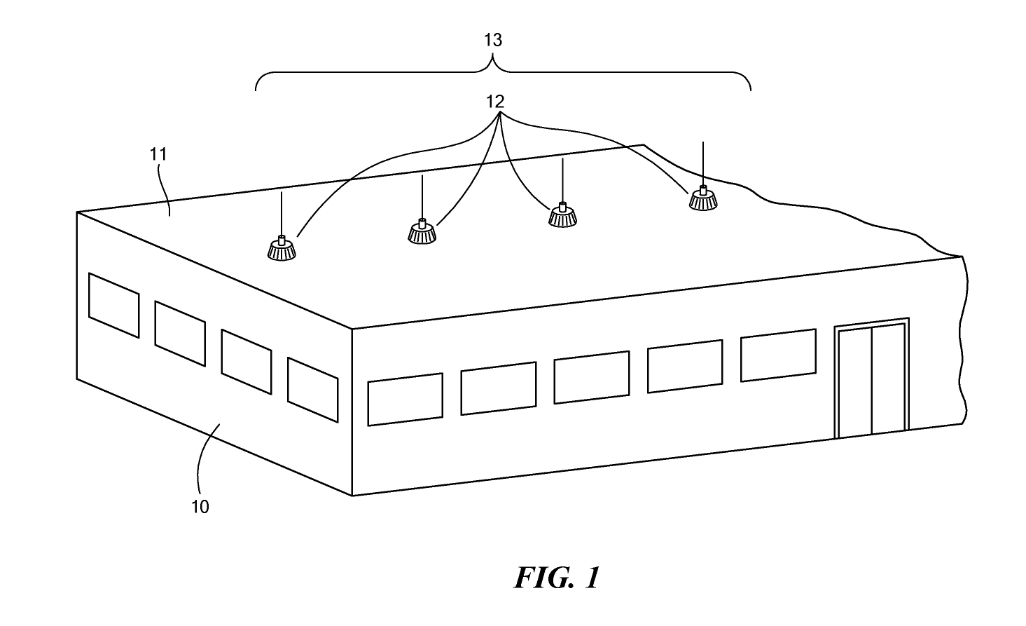

### High-Visibility Roof-Drain System, FIGS. 1-6

A first embodiment of a high-visibility roof-drain system, for installation and use in a flat-roof building, is shown in FIG. 1. The system includes one or more high-visibility roof-drain covers.

FIG. 1 shows building 10 having flat roof 11 and high-visibility roof-drain system 13. A top portion of each of the high-visibility roof-drain covers 12 is shown in FIG. 1 protruding from flat roof 11. FIG. 1 shows high-visibility roof-drain system 13 including four high-visibility roof-drain covers 12.

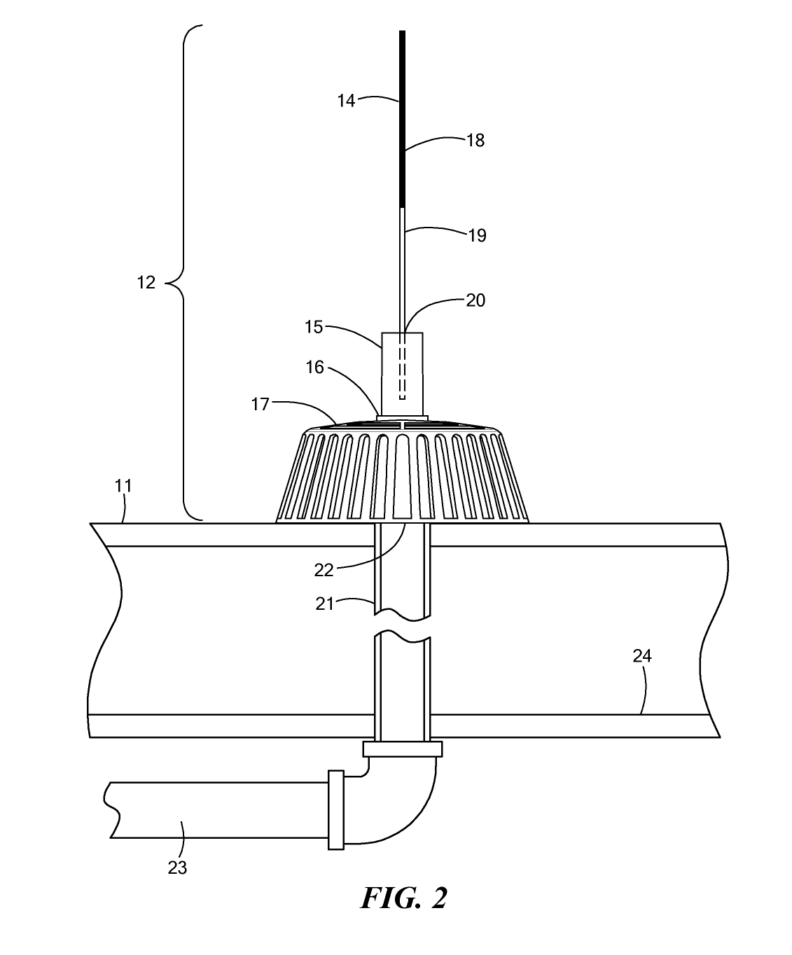

FIG. 2 provides a partial cross-section view of a high-visibility roof-drain system 13, showing just one high-visibility roof-drain cover 12.

The high-visibility roof-drain cover 12 shown in FIG. 2 includes one elongated reversible flag 14, one flag coupler 15, one top washer 16, one roof-drain cover 17 defining a central aperture 25, one bottom washer, and one nut. (See FIG. 6 for bottom washer 27 and nut 28).

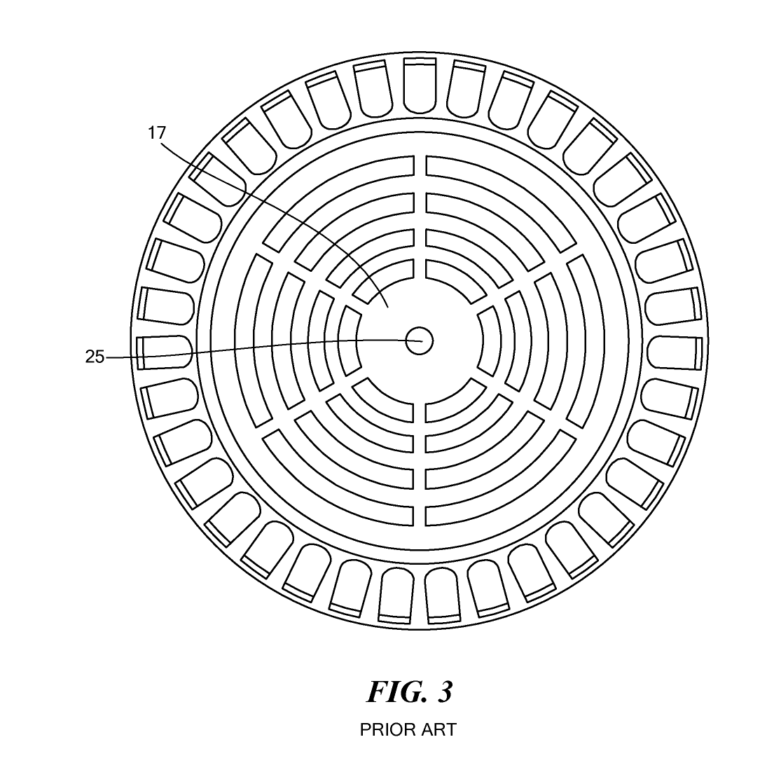

Other elements included in high-visibility roof-drain cover 12, but not shown in FIG. 2, are the central aperture 25 defined by roof-drain cover 17 (see FIG. 3), bottom washer 27, and nut 28 (sec FIG. 6).

FIG. 2 shows high-visibility roof-drain system 13 having one substantially vertical internal drainpipe 21, one drainpipe inlet 22, and one drainpipe outlet 23.

FIG. 2 also shows elongated reversible flag 14 defining a first flag end 18 and a second flag end 19. First flag end 18 and second flag end 19 are marked differently such that first flag end up is visibly distinguishable over second flag end up. At least one of an associated pair of flag ends is visibly marked so that “first flag end up” is visibly distinguishable over “second flag end up”. The benefit of this structure is that reversing the orientation of the flag, after inspecting the roof-drain-cover, provides a visual indication that an inspection has been performed. Both flag ends are sized the same to allow push fit of either flag end into flag socket 20 of flag coupler 15.

FIG. 2 also provides a partial cross-section view of internal drainpipe 21, drainpipe inlet 22, and drainpipe outlet 23. Roof-drain cover 17 may be positioned on, or sunk into, flat roof 11.

Internal drainpipe 21 extends downward from drainpipe inlet 22, proximate to flat roof 11 to drainpipe outlet 23, preferably below the foundation 24 of the building so that water may flow from drainpipe inlet 22 to down through internal drainpipe 21 to exit via drainpipe outlet 23.

FIG. 2 further shows elongated reversible flag 14 extending upwardly when attached to flag coupler 15.

FIG. 3 is a top view of prior roof-drain cover 17 having a central aperture 25. (See also central aperture 25 in FIG. 6).

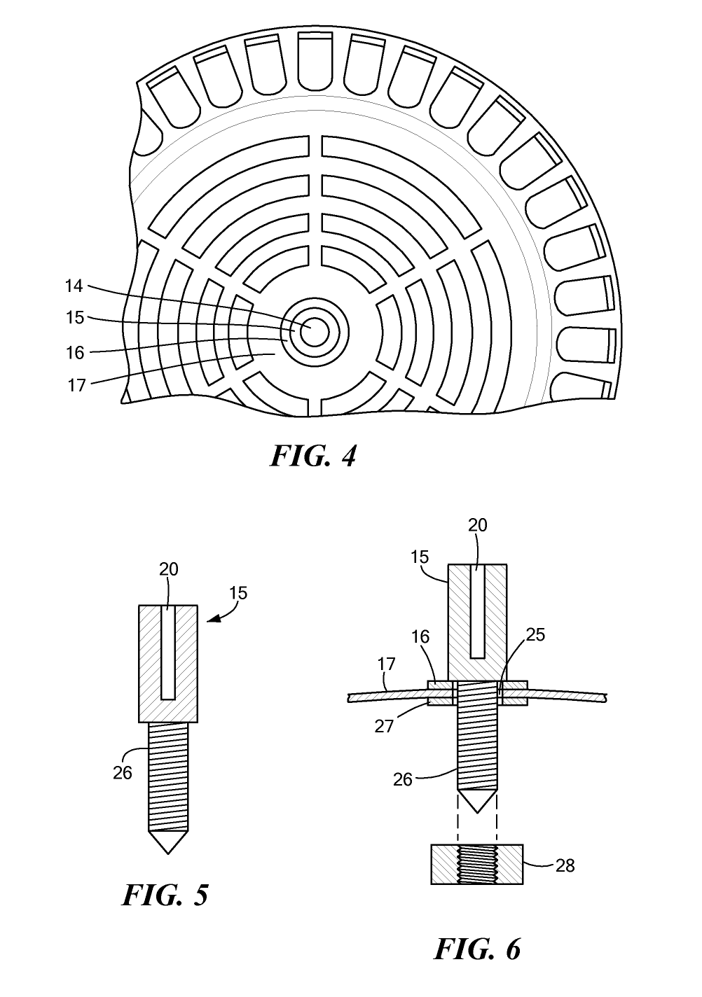

FIG. 4 is a top view of one high-visibility roof-drain cover 12 shown in FIG. 2. FIG. 4 locates elongated reversible flag 14, flag coupler 15, top washer 16, and roof-drain cover 17.

FIG. 5 shows a first embodiment of flag coupler 15. This first embodiment of flag coupler 15 defines flag socket 20, and is characterized by threaded stub 26.

FIG. 6 shows flag coupler 15 attached to roof-drain cover 17 using threaded stub 26 and nut 28. Threaded stub 26 is shown passing through central aperture 25 of roof drain cover 17, and nut 28 is poised to thread onto threaded stub 26.

### Second Embodiment

### High-Visibility Roof-Drain System, FIGS. 1-7

A second embodiment is illustrated in FIGS. 1-7.

FIGS. 1-7 show a second embodiment of a high-visibility roof-drain system 13 similar to the first embodiment. In this second embodiment flag coupler 35 includes threaded side aperture 36 and a thumbscrew 37. This second embodiment is the preferred embodiment of the high-visibility roof-drain system 13.

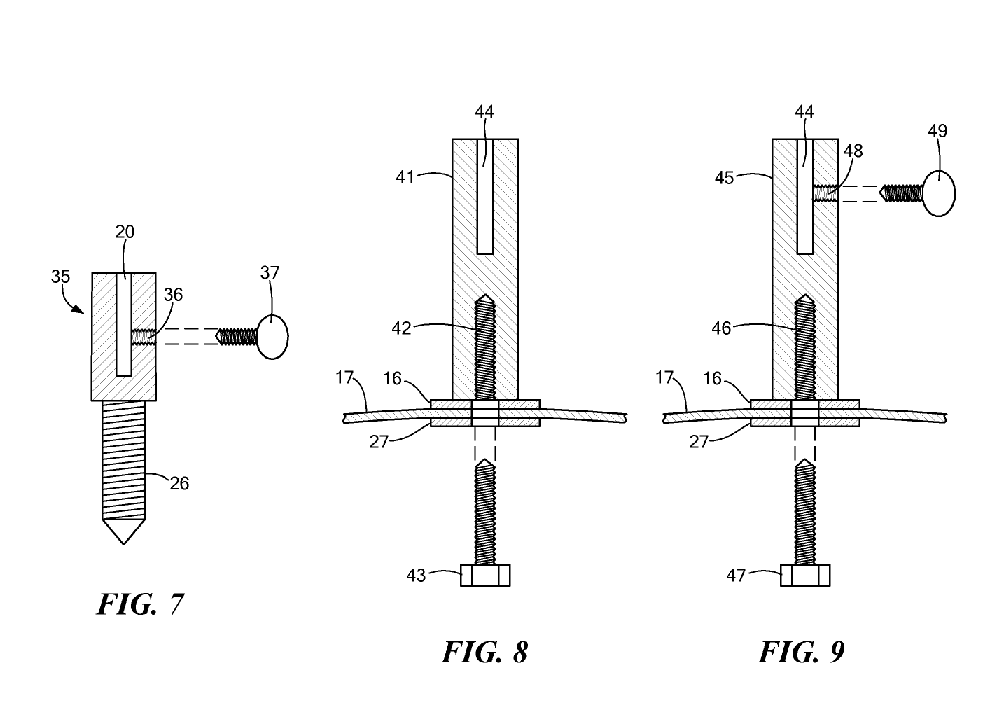

FIG. 7 shows a second embodiment having a flag couple 35, a threaded side aperture 36 running from one side of flag coupler 35, into flag socket 20, and a thumbscrew 37, the thumbscrew locking either first flag end 18 or second flag end 19 into flag socket 20.

### Third Embodiment

### High-Visibility Roof-Drain System, FIGS. 1-4 and 8

A third embodiment is illustrated in FIG. 1-4 and 8.

FIG. 1-4 and 8 show a third embodiment of a high-visibility roof-drain system 13, similar to the first embodiment wherein flag coupler 41 includes a lower threaded cavity 42, a bolt 43, and a threaded flag socket 44.

### Fourth Embodiment

### High-Visibility Roof-Drain System FIGS. 1-4 and 9

A fourth embodiment is illustrated in FIGS. 1-4 and 9. The parts of FIGS. 1-4 are described above in disclosure of the first embodiment, e.g. prior art roof-drain cover 17 with central aperture 25 as shown in FIG. 3.

FIGS. 9 provides a cross-section view of a top portion of flag coupler 45 a cross-section view of flag socket 44 and a cross-section view of lower threaded cavity 46. Flag coupler 45 includes threaded side aperture 48 and thumbscrew 49.

The fourth embodiment is similar to the third embodiment, except that flag coupler 45 uses thumbscrew 49 screwed into threaded side aperture 48 to attach elongated reversible flag 14 to roof-drain cover 17.

FIG. 9 further shows bolt 47 poised to move upward by threading into lower threaded cavity 46, so as to compress roof-drain cover 17 and top and bottom washers 16 and 27 respectively. Further tightening bolt 47 into lower threaded cavity 46, securely attaches flag coupler 45 to roof-drain cover 17.

### Fifth Embodiment

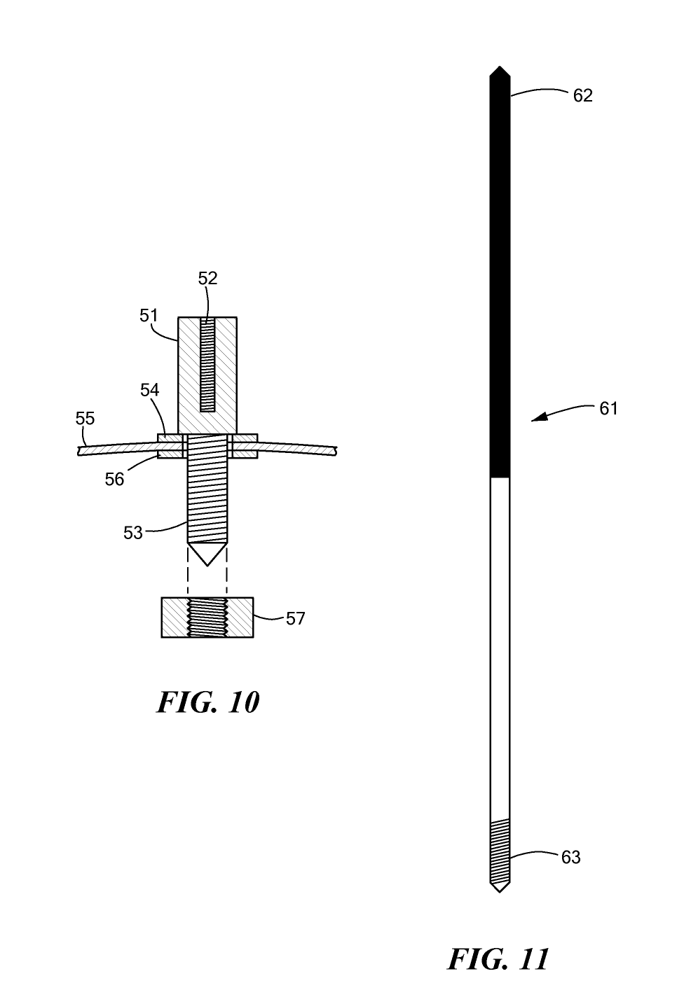

### High-Visibility Roof-Drain System, FIGS. 10-11

A fifth embodiment is illustrated in FIGS. 10-11.

FIGS. 10-11 show parts of a fourth embodiment of a high-visibility roof-drain system 13 for installation and use within a flat-roof building. This fourth embodiment includes a flag coupler having a threaded stub 53 and a nut 57, and an elongated reversible lockable flag 61 having first and second flag-locking threaded ends.

FIG. 10 shows a cross-section view of a top portion of flag coupler 51 and a cross section view of threaded flag socket 52, and a front view of threaded stub 53.

FIG. 10 also shows flag coupler 51 and its surrounding components, including roof-drain cover 55. Roof-drain cover 55 is substantially identical to prior art roof-drain cover 17 (with central aperture 25) as shown in FIG. 3.

FIG. 10 further shows nut 57 poised to thread onto threaded stub 53, riding in a direction to urge the upper and lower washers 54 and 56 together, squeezing roof-drain cover 55 between them. Further tightening nut 57 on threaded stub 53 securely attaches flag coupler 51 to roof-drain cover 55.

FIG. 11 shows a front view of elongated reversible lockable flag 61 having first and second flag-locking threaded ends 62 and 63. Locking either one of threaded ends 62 or 63 into threaded flag socket 52 will securely attach the flag to the flag coupler.

### Sixth Embodiment

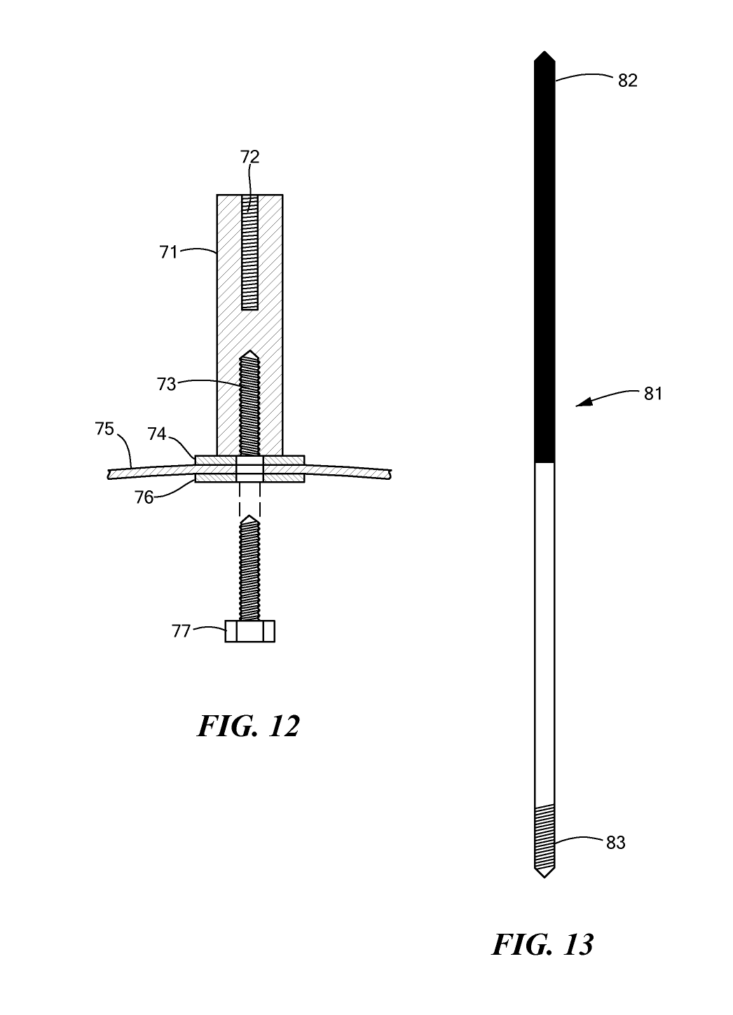

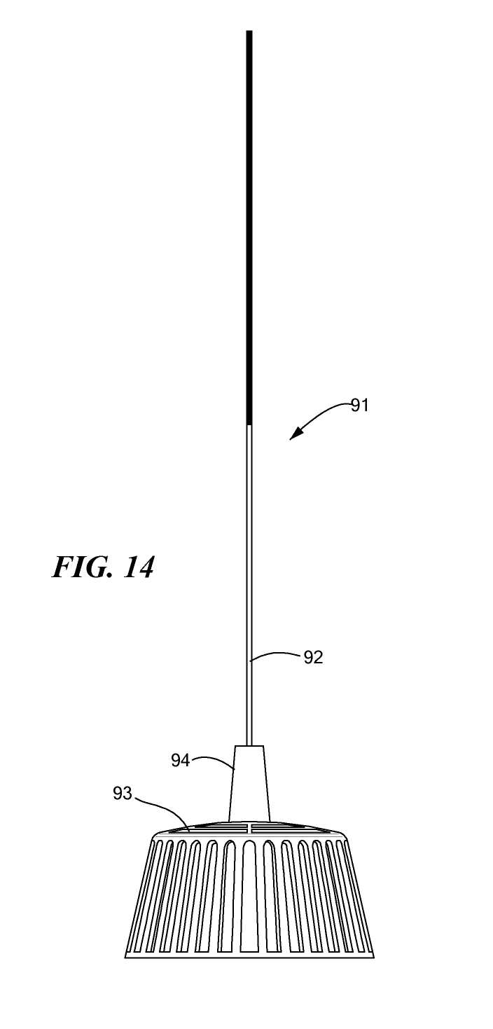

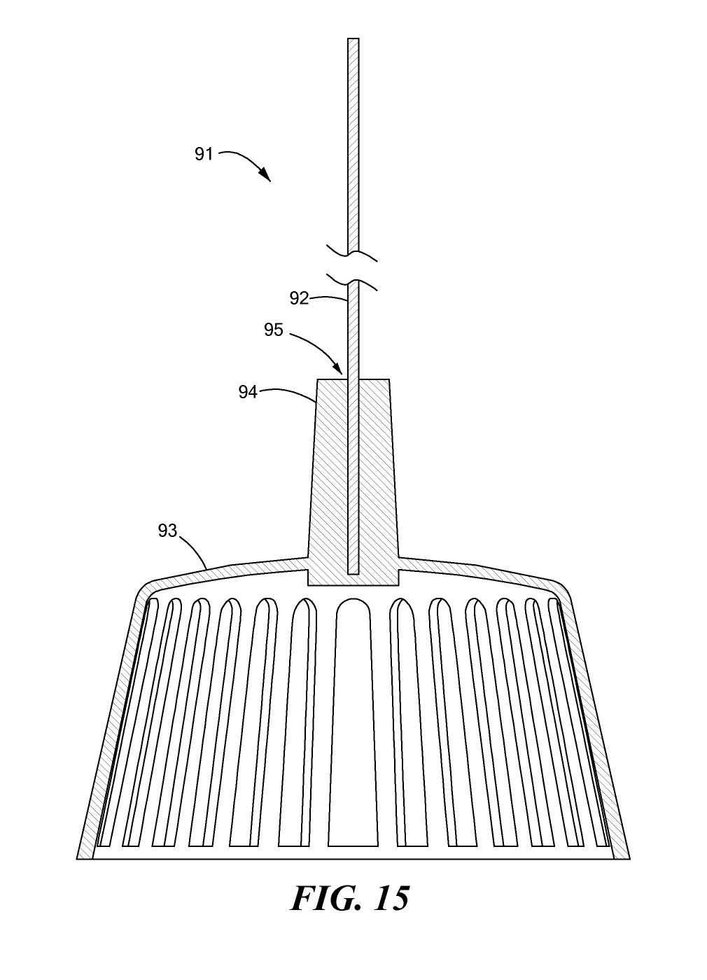

### High-Visibility Roof-Drain System, FIGS. 12-13

A Sixth embodiment is illustrated in FIGS. 12-13.

FIGS. 12-13 show parts of a sixth embodiment of a high-visibility roof-drain system for installation and use within a flat-roof building. This a sixth embodiment includes a flag coupler 71 having a lower threaded cavity 73 and a bolt 77, and an elongated reversible lockable flag 81 having first and second flag-locking threaded ends 82 and 83.

FIG. 12 shows a cross-section view of a top portion of flag coupler 71 and a cross-section view of threaded flag socket 72, and a front view of lower threaded cavity 73.

FIG. 12 shows flag coupler 71 and its surrounding components, including roof-drain cover 75. Roof-drain cover 75 is substantially identical to prior art roof-drain cover 17 (with central aperture 25) as shown in FIG. 3.

FIG. 12 also shows bolt 77 poised to thread into lower threaded cavity 73, riding in a direction to urge the two washers 74 and 76 together, squeezing roof-drain cover 75 between them. Further tightening bolt 77 into lower threaded cavity securely attaches flag coupler 71 to roof-drain cower 75.

FIG. 13 shows a front view of elongated reversible lockable flag 81 having first and second flag-locking threaded ends 82 and 83. Locking either one of threaded ends 82 or 83 into threaded flag socket 82 will securely attach the flag to the flag coupler.

### Seventh Embodiment

### High-Visibility Roof-Drain Cover, FIGS. 14-18

A seventh embodiment is illustrated in FIGS. 14-18.

FIGS. 14-18 show high-visibility roof-drain cover 91 for installation and use in a flat-roof building.

FIG. 14 provides a front view of high-visibility roof-drain cover 91 consisting of elongated reversible flag 92 and centered boss 94 defined by roof-drain cover 93.

FIG. 15 provides a front cross-section view of flag 92 mounted to roof-drain cover 93 via centered boss 94 and flag socket 95. Flag socket 95 is sized to accept either end of an elongated reversible flag 92.

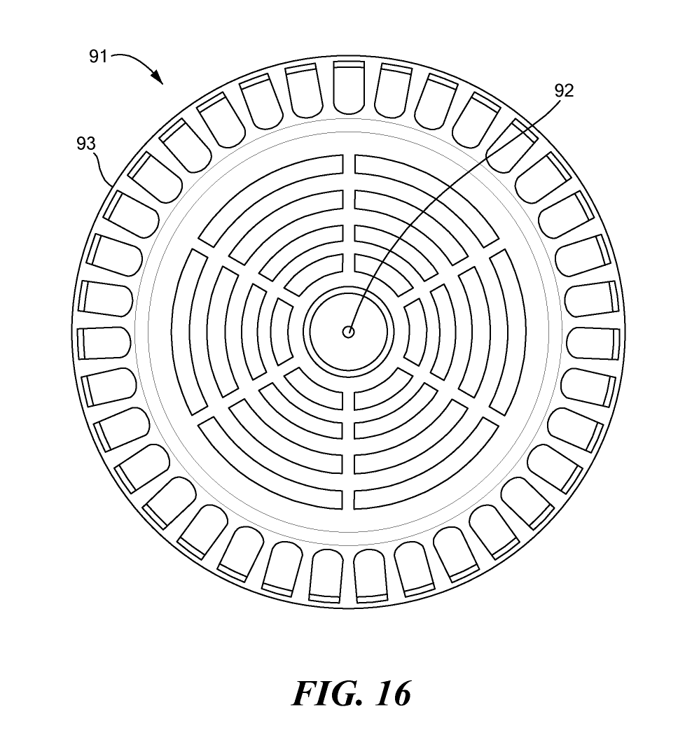

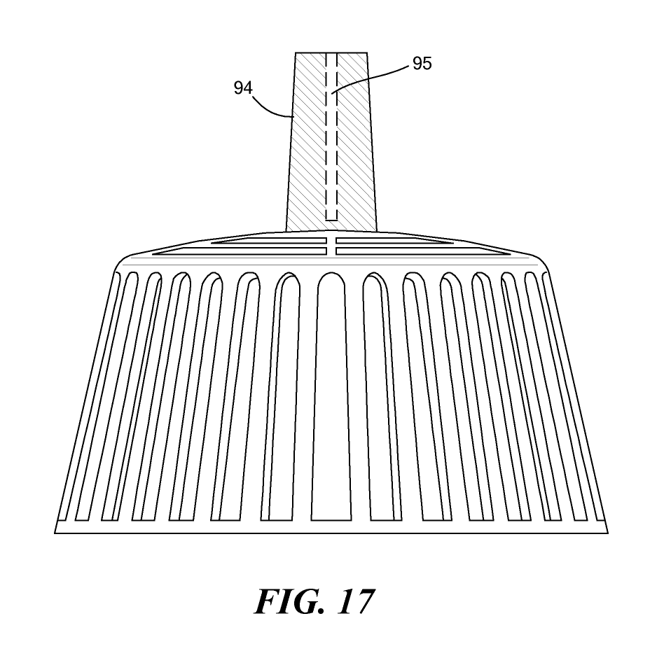

FIG. 16 provides a top view of high-visibility roof-drain cover 91 showing flag 92 and roof-drain cover 93.

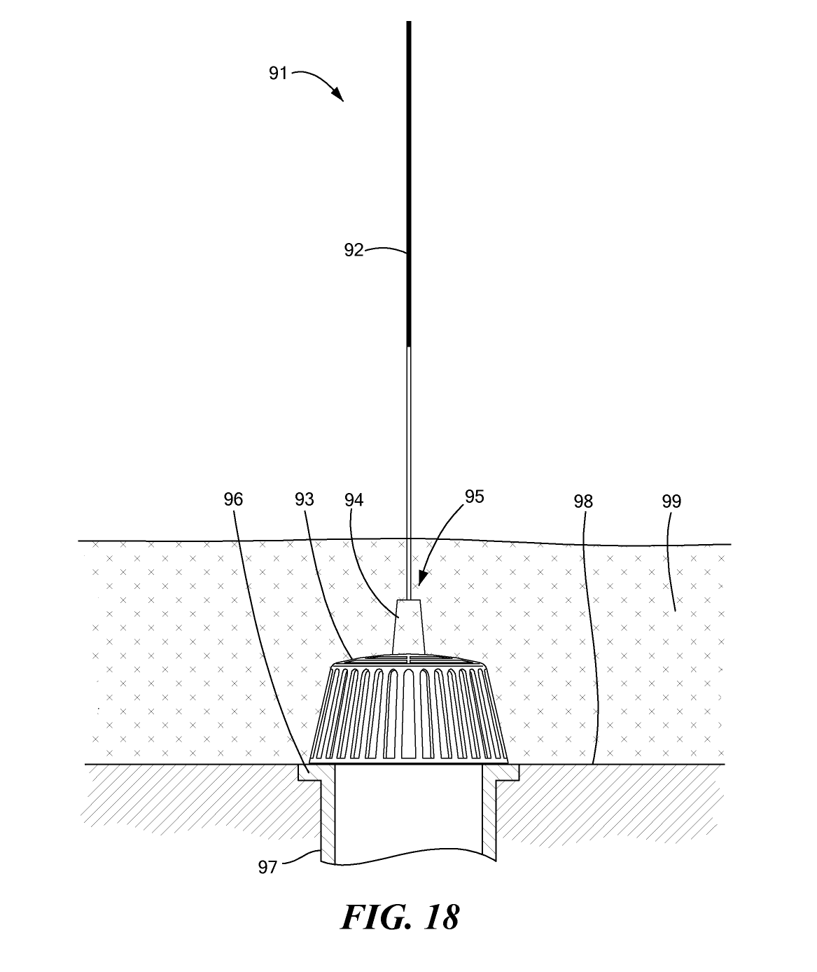

FIG. 17 provides a front cross-section view of centered boss 94 and flag socket 95.

FIG. 18 provides front view of high-visibility roof-drain cover 91 sitting on the rim 96 of internal drainpipe 97. Rim 96 is proximate to roof top 98, with roof-drain cover 93 buried under a layer of snow 99.

Methods for Monitoring a Roof Drain System

A first method for monitoring the clearing of blockages or debris from the roof-drain cover of a high-visibility roof-drain system, the system having an elongated reversible flag mounted to the roof-drain cover, includes the steps of: 1) clearing blockages or debris from a roof-drain cover, 2), reversing the orientation of the flag; and 3) thereby providing a visual indication that an inspection has been performed.

A second method includes the steps of the first method and the following step:

having an authorized facilities inspector clear blockages or debris from the roof-drain cover and reverse the flag.

A third method includes the steps of the first method and the following two steps:

having an authorized facilities monitor observe the flag shortly before and shortly after the time period during which a clearing of blockages and debris had been scheduled to occur, and having the authorized facilities monitor record his or her observations, and take appropriate action following the event.

A fourth method includes the steps of the first method and the following thee steps:

mounting a roof-drain cover on the roof of a flat-roof building, mounting an elongated reversible flag to the roof-drain cover, and marking at least one flag end to distinguish between the two flag ends so that “first flag end up” is visibly distinguishable over “second flag end up.

What is claimed is:

1. A high-visibility roof-drain system for installation and use in a building having a flat roof and a substantially vertical internal drainpipe running essentially from top to bottom in the building, the high-visibility roof-drain system comprising:
a roof-drain cover defining a central aperture, the roof-drain cover mounted on or above the flat roof;
an elongated reversible flag mounted to the roof-drain cover, the flag having a first flag end and a second flag end; and
a flag coupler having flag socket means for accepting a flag end;
wherein the first flag end is up when the second flag end is mounted to the roof-drain cover, and the second flag end is up when the first flag end is mounted to the roof-drain cover; and
wherein at least one of the flag ends is visibly marked such that first flag end up is visibly distinguishable over second flag end up; and
such that reversing the vertical orientation of the flag, after an inspection has been performed on the roof-drain cover, provides a visual indication that an inspection has been performed.

2. A high-visibility roof-drain system according to claim 1, further comprising:
a flag coupler defining a flag socket, the flag socket sized to accept a flag end therein.

3. A high-visibility roof-drain system according to claim 1, wherein the flag coupler includes a threaded stub sized to pass through the central aperture and an associated nut, wherein the flag coupler is secured the to the roof-drain cover by tightening the nut on the threaded stub.

4. A high-visibility roof-drain system according to claim 1, wherein the flag coupler further includes a threaded side aperture and an associated thumbscrew to lock a flag end to the flag coupler.

5. A high-visibility roof-drain system according to claim 1, wherein the flag coupler includes a threaded lower cavity and an associated bolt, wherein the flag coupler is secured the to the roof-drain cover by a tightening of the bolt within the threaded lower cavity.

6. A high-visibility roof-drain system according to claim 5, wherein the flag coupler further includes a threaded side aperture and an associated thumbscrew to lock a flag end to the flag coupler.

7. A high-visibility roof-drain system according to claim 3, wherein the flag defines a first threaded end and a second threaded end, and one or other of the two threaded ends is screwed into the threaded flag socket.

8. A nigh-visibility roof-drain cover for installation and use in a flat-roof building having a substantially vertical internal drainpipe running essentially from top to bottom in the building, the high-visibility roof-drain cover comprising:
an elongated reversible flag mounted to the roof-drain cover, the flag having a first flag end and a second flag end; and
a roof-drain cover having a central boss that defines a flag socket sized to accept either the first flag end or the second flag end;
wherein the first flag end is up when the second flag end is mounted to the roof-drain cover; and
wherein the second flag end is up when the first flag end is mounted to the roof-drain cover; and
wherein at least one of the flag ends is visibly marked;
such that first flag end up is visibly distinguishable over second flag end up; and such that reversing the vertical orientation of the flag, after inspecting the roof-drain cover, provides a visual indication that an inspection has been performed.

9. A method for monitoring the clearing of blockages or debris from the roof-drain cover of a high-visibility roof-drain system, the system having an elongated reversible flag mounted to the roof-drain cover, the method comprising the steps of:
clearing blockages or debris from a roof-drain cover;
reversing the orientation of the flag; and
thereby providing a visual indication that an inspection has been performed.

10. A method according to claim 9, further comprising the steps of:
having an authorized facilities inspector clear blockages or debris from the roof-drain cover and reverse the flag.

11. A method according to claim 9, further comprising the steps of:
having an authorized facilities monitor observe the flag shortly before and shortly after the time period during which a clearing of blockages and debris had be scheduled to occur; and
having the authorized facilities monitor record his or her observations, and take appropriate action following the event.

12. A method according to claim 9, further comprising the steps of:
mounting a roof-drain cover on the roof of a flat-roof building;
mounting an elongated reversible flag to the roof-drain cover; and
marking at least one flag end to distinguish between the two flag ends so that “first flag end up” is visibly distinguishable over “second flag end up.
